(19) United States
(12) Patent Application Publication
(10) Pub. No.: US 2023/0240936 A1
(43) Pub. Date: Aug. 3, 2023

(54) HEAT CABIN WITH HOT AIR EXTRACTION

(71) Applicant: BodyPhoton GmbH, Schwalbach Am Taunus (DE)

(72) Inventor: Hans-Jürgen Volz, Bad Nauheim (DE)

(21) Appl. No.: 18/109,413

(22) Filed: Feb. 14, 2023

Related U.S. Application Data
(63) Continuation of application No. PCT/EP2021/000094, filed on Aug. 10, 2021.

(30) Foreign Application Priority Data
Aug. 14, 2020 (EP) 20000286.3-1122

(51) Int. Cl. A61H 33/06; F24F 7/013

(52) U.S. Cl. CPC A61H 33/067; A61H 33/063; F24F 7/013; A61H 2033/061

(57) ABSTRACT

The present invention relates to a heat cabin with hot air extraction. In particular, it relates to a heat cabin (10) which is equipped with a heat supply and an exhaust air system, wherein the heat cabin (10) comprises support beams (42) and cladding panels (40) and the cladding panels (40) are aligned perpendicular to a wall or ceiling normal, and the exhaust air system comprises exhaust air openings (50) in the cladding panels (40), whose shape is determined by the support beams (42) and/or the cladding panels (40) and which have no through passage parallel to the wall or ceiling normal. Furthermore, it relates to a method for operating a heat cabin.

### FIELD OF THE INVENTION

The present invention relates to a heat cabin with hot air extraction. This heat cabin allows for improved heating that is more pleasant for a user. The cabin is preferably a sauna or a training cabin.

### BACKGROUND OF THE INVENTION

There is a plurality of heat cabins and corresponding methods and devices for heating these cabins.

German patent specification made available for public inspection 1 089 092 discloses a planar radiant heater for mounting in a wall, in particular in a bathroom. This radiant heater draws its heat from a heat conductor. The heat conductor is insulated at the back by a reflector. At the front, the heat conductor heats a radiant surface which faces the room. The radiant surface is additionally protected by protective bars to prevent burns.

This radiant heater is configured such that a most uniform heat distribution is achieved, and convection heating is avoided.

US patent application US 2008/0292293 discloses a heating element which works using linen carbon fibers. A large heating surface is achieved thereby. This can cover a wall, completely or also for the most part. As the material of the heating element is not only flat, but also flexible, rolling the heating element like a roller blind in a box also comes into consideration.

The present invention would provide a heat cabin with hot air extraction in a simple and economical way. The heat cabin is to allow for a particularly pleasant experience. In particular, drafts are to be avoided and the heat is to be added primarily by radiant heating. Thus, convection heating is to be completely or largely avoided. In this respect, operating modes are also possible, in which the radiant heat acts on the user and, e.g., makes physical training more comfortable and efficient; however, the user does not feel “hot”. The heat cabin may thus be used across a broad temperature range. Above all, an optimal wavelength and intensity of the infrared ration may be set without the occurrence of undesired heating. Radiation and temperature may thus be decoupled very well. Furthermore, a visually appealing and easily manufacturable heat cabin is to be created. The invention also relates to a corresponding method.

### DESCRIPTION

A heat chamber according to the present invention may be, for example, a heat chamber for laboratory or testing purposes, and also a sauna or training room. It has been demonstrated that physical training or also rehabilitation training at increased temperatures (for example, at approximately body temperature) is more effective than training at a typical room temperature of approximately 20° C. Furthermore, radiation has, regardless of the room heating, a positive effect on the human body, particularly during physical activities for training or rehabilitation purposes. This type of cabin may be used by one or more persons.

The heat cabin according to the invention has a heat supply. This heat supply may be internal or external. For example, a supply of external hot air would be conceivable. The heat supply may also be provided in the form of a heater. For example, a heater may be provided in the cabin, for example, an infrared heater/radiator. An appropriate infrared heating may also be provided in the form of a flush-to-the-wall heating plate. This heating plate may substantially have the shape of wall panels, so that the heating is provided as a heatable wall panel.

The heat cabin is to comprise support beams and cladding panels. It may consist completely or substantially out of these elements. The support beams may, for example, be provided made of wood or metal. These support beams may be clad internally and externally by wall panels. The ceiling may also be formed by support beams, which are likewise covered internally and externally by cladding panels (a support beam may be generally understood in the context of this invention to also be a support element, for example, a support frame or support batten).

The cladding panels are aligned perpendicular to a wall or ceiling normal (expressed in another way, perpendicular to the wall or ceiling surface). The walls or ceilings of the heat cabin are predominantly or substantially flat, so that the wall or ceiling normals may be identified for each wall (or, if necessary, in relation to the entire cabin structure). For example, the wall normal is precisely perpendicular to a flat wall. The wall and ceiling normals mutually face the center of the heat cabin and may, for example, meet in the geometric center of the heat cabin in the case of a cuboidal heat cabin.

The heat cabin is to further comprise an exhaust air system, which comprises exhaust air openings in the cladding panels. The shape of these exhaust air openings may be determined completely by the cladding panels. The shape of this exhaust air opening may also be co-determined by the support beams. The shape of the exhaust air openings is often determined by the shape of the support beams and the shape of the cladding panels. For example, an opening may be designed partially in the support beam and partially in the cladding panel.

In the context of the present invention, it was recognized that a heat cabin, which has a two-part exhaust air opening, is generally advisable. The first part of the exhaust air opening may be formed by a joint, for example, by a joint between two wall panels or by a joint between a wall panel and a support element. The second part of the exhaust air opening may be formed by a duct arranged therebehind, which supplies air in a direction that differs from the air direction prevailing in the joint. For example, the air direction in the duct or the duct as a whole may be angled with respect to the passage direction of the joint and the orientation of the joint. The corresponding angle appropriately lies between 10 and 90°, appropriately also between 45 and 90°. A fresh air opening may be provided by two parts, analogously to how this is described for the exhaust air opening.

In the context of the present invention, it was further recognized that a heat cabin is generally appropriate, in which wall and/or ceiling panels are used, and the exhaust air openings and/or the fresh air openings are covered by sections of the panels. It is thereby to be expressed by the expression “and/or” that this may be realized for the wall panels, or for the ceiling panels, or for the wall panels and for the ceiling panels.

The exhaust air openings of the exhaust air system of the heat cabin are not to have any through passage parallel to the wall or ceiling normals, this means, no through passage parallel to the ceiling normals is to exist in the case of an exhaust air opening which is provided in the ceiling. In the case of an exhaust air opening which is provided in a wall, possibly also in its edge area, the exhaust air opening is not to provide any through passage parallel to the wall normal. Such a through passage would be one, through which light might perpendicularly enter or exit, or air might flow through on a dead straight path.

The exhaust air opening thus also covers elements arranged behind it, which is generally also visually desirable. For example, the panels may be configured on a large scale as IR heating panels, as they are completely or substantially free from air inlets and outlets, they. Alternatively or additionally, panels may therefore also be used as projection surfaces, for example, to project training instructions, decorative elements, and entertainment offerings.

A through passage parallel to the wall normal is understood to be a straight through passage, thus one which a light beam might follow. It is appropriate if a through passage is only possible at an angle to the normals, and lies between 5° and 80°, preferably between 20° and 60° or between 30° and 45°.

A heat cabin is appropriate, in which at least one cladding panel comprises at least one longitudinal edge for contact on a support beam. It may be completely appropriate if several cladding panels or indeed all cladding panels comprise at least one such longitudinal edge. This applies both for the wall panels and also for the ceiling panels. It is appropriate if contact surfaces and openings are provided intermittently on such a longitudinal edge. Using the contact surfaces, the cladding panel lies flush on the support beam. The panel does not contact the support beam in the area of the openings, so that the openings may function as exhaust air openings. Recesses may also be provided on the support beam corresponding to the openings in the cladding panel. However, a corresponding opening in the cladding panel may often already offer an appropriate exhaust air opening.

The openings on the longitudinal edges may thus provide complete exhaust air openings in this meaning, or at least provide a part of an exhaust air opening, wherein the remaining part of the exhaust air opening is provided by other components, for example, by support beams with the mentioned recesses. In this way, cladding panels may be advantageously manufactured, which may be connected well and securely to the support beams with the aid of the contact surfaces, and which also provide exhaust air openings of the type according to the invention. These exhaust air openings are then appropriately covered by other sections of the cladding panels in such a way that there is no through passage parallel to a normal of the cladding panel. Such cladding panels allow the invention to be implemented in a cost-effective way. They are additionally easy to manufacture. This applies in particular if the cladding panel(s) is/are manufactured from wood or a plastic material. Openings close to the edge may appropriately be provided by milled areas. This also applies if a plastic composite material is used.

The exhaust air openings on the walls, in particular in the edge areas of the walls, may thus be appropriately provided close to the room corners or ceiling edges. The exhaust air openings may also be appropriately provided at the ceiling. Rising warm air is then extracted via exhaust air openings at the ceiling. It is advantageous if the exhaust air openings are provided in the upper 10% of the room height.

The wall surfaces and the ceiling surfaces may be divided into a central wall surface, for example, a central rectangle, and a surrounding edge surface. The central surface may thereby occupy 90% of the wall surface, and the remaining, surrounding, near-wall surface may occupy 10% of the wall surface. It is advantageous if the exhaust air openings are provided in the surface close to the edge, in particular if this surface measures 20% of the wall surface or if it measures 10% of the wall surface. This correspondingly applies for the ceiling surfaces.

A heat cabin has also proven appropriate, in which a wall surface is equipped with an infrared heater and at least one exhaust air opening is arranged in the ceiling surface above the infrared heater. This exhaust air opening may appropriately be arranged in a cladding panel in the ceiling surface above the infrared heater. Alternatively, an exhaust air opening might also be provided in the upper area of the wall above the infrared heater, thus adjacent to the ceiling. The infrared heater is appropriately mounted on the wand or recessed into the wall, for example, in that a panel heated by the infrared heater is connected to adjacent wall panels.

A heat cabin is also appropriate which has an interior ceiling and an exterior ceiling. In the case of this heat cabin, (at least) two ceiling surfaces are carried out substantially parallel. A cavity may be formed between the ceiling surfaces. It is appropriate if at least one exhaust air opening is provided in the interior ceiling. This may appropriately lead into the cavity between the interior ceiling and the exterior ceiling. It is further appropriate if an exhaust air duct, which may receive air from the exhaust air opening of the interior ceiling and may guide it out of the cabin, is provided in the exterior ceiling. It is thereby particularly appropriate if the exhaust air duct(s) in the exterior ceiling allow for a larger air throughput than the exhaust air opening(s) in the interior ceiling. For this purpose, the cross sections of the exhaust air ducts in the exterior ceiling may be greater in sum than the sum of the cross sections of the exhaust air openings in the interior ceiling. A larger air throughput of the exhaust air ducts of the exterior ceiling may also be achieved by ventilation, for example, by electrically-driven fans.

In order to ensure a good exhaust air flow, it is also appropriate if a negative-pressure space is created between the interior ceiling and the exterior ceiling. Fans may likewise be used for this purpose.

In the context of the present invention, a controllable exhaust air system is the general objective. A controllable fresh air system may also be provided. The control may be carried out via controllable fans in the exhaust air and/or fresh air system.

A good exhaust air flow, as is already achieved solely by the exhaust air openings according to the invention, and also by means of the equipment mentioned, also allows for efficient use of the cabin. This may be used by more users simultaneously, without an impression arising of stale or poor air.

It is also appropriate if a fresh air supply is additionally provided in the case of the heat cabin according to the invention. This type of fresh air supply may be configured in that fresh air openings are provided in cladding panels (of the walls or ceilings). The fresh air openings may be configured like the exhaust air openings. In particular, the shape of the fresh air openings may be determined by the shape of the support beams and/or the cladding panels. The fresh air openings also ought to have no direct through passage parallel to the wall or ceiling normals. It is appropriate if a through passage is only possible at an angle to the normals, and lies between 5° and 80°, preferably between 20° and 60° or between 30° and 45°.

The fresh air openings are preferably provided in cladding panels of the wall. These cladding panels may also have contact surfaces and openings intermittently on at least one longitudinal edge for contact on a support beam. The openings may provide exhaust air openings in their entirety, or provide exhaust air openings in interaction with other components.

A heat cabin is also appropriate, in which heating elements are provided, and in which fresh air openings are arranged underneath the heating elements. Infrared heaters are considered again as heating elements, particularly those which are available to be set flush to the wall. The fresh air openings may then be arranged underneath the infrared heating elements, best at floor level. It is advantageous if the fresh air openings are provided in the lower 10% of the room height. It is likewise advantageous if the fresh air openings are provided in the surface of the walls close to the edge (as defined for the exhaust air openings), in particular if this surface measures 20% of the wall surface or if it measures 10% of the wall surface.

It is likewise advantageous if the walls of the heat cabin also have an interior wall and an exterior wall. The fresh air openings may then be provided in the interior wall. Additional fresh air ducts may be provided in the exterior wall. The diameter of the fresh air openings in the exterior wall may thereby be greater than the diameter of the fresh air openings in the interior wall, corresponding to that which was described for the exhaust air ducts and exhaust air openings. It is appropriate to provide the interior fresh air openings in the lower wall area; however, to provide the fresh air ducts in the exterior walls in the upper wall area. This leads to the fresh air being guided along the wall from above to below before it penetrates into the cabin.

This fresh air supply avoids drafts. At the same time, the fresh air may be preheated, if infrared heaters are provided on the interior walls, or if infrared heaters are embedded into the interior walls, which preheat the supplied fresh air.

A heat cabin according to the invention may be equipped with a fresh air supply. In conventional cabins and saunas, the fresh air supply takes place in an unregulated way, for example, through the door gap or by opening the door. A fresh air supply, in particular, however, the described fresh air supply and the possible configurations allow for the controlled supply of fresh air. In particular, the supplied fresh air may be thereby filtered. The use of FFP2, FFP3 or HEPA filters thereby comes into consideration. The supply of purified fresh air is thus possible, in particular the supply of the same with low pollen, dust, or viral loads.

In the case of the cabin according to the invention, 70% to 100%, e.g., also more than 90% of the supplied air is supplied via the fresh air openings. Doors and potential cabin windows may therefore close tightly.

The invention relates to a method for heating a heat chamber. In this method, at least one first infrared element is to be used. A fresh air opening is arranged underneath this infrared heating element and an exhaust air opening is arranged above the infrared heating element.

It is particularly appropriate if, in the case of this method, cladding panels are used on the wall and/or ceiling, and the fresh air openings and the exhaust air openings are covered by sections of these cladding panels.

Further features, and also advantages of the invention, arise from the subsequently explained drawings and associated description. Features of the invention are described in combination in the figures and in the associated descriptions. However, these features may also be included in other combinations by subject matter according to the invention. Each disclosed feature is thus also to be considered to be disclosed in technically logical combinations with other features. The figures are slightly simplified in part and schematic.

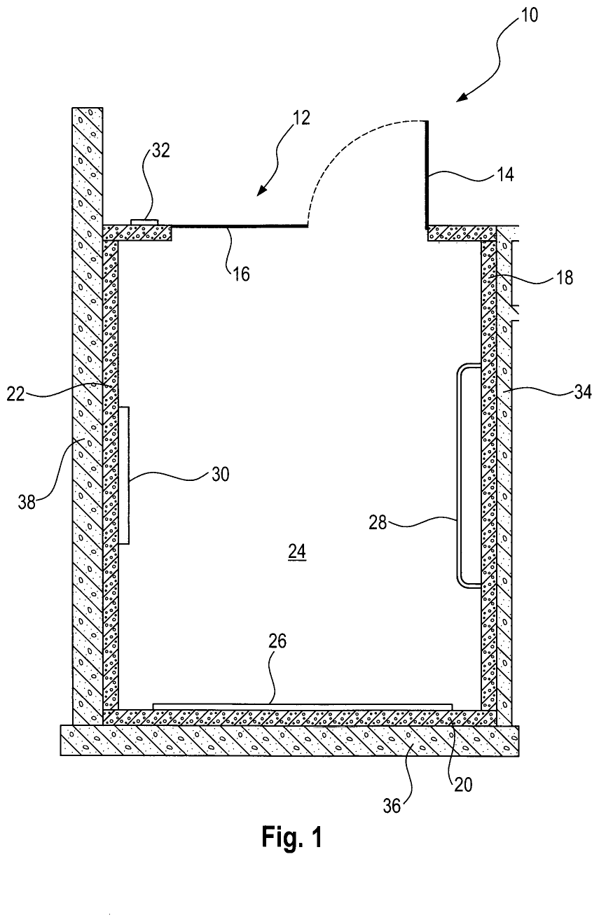

FIG. 1 is a floor plan drawing which shows an exemplary heat chamber

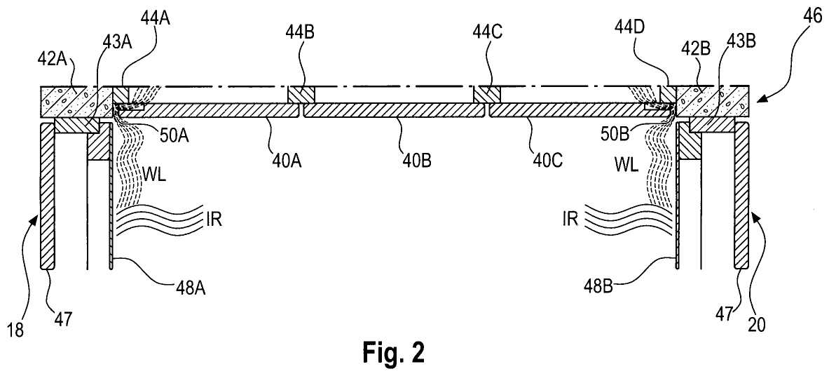

FIG. 2 is a sectional view through a heat chamber according to the invention

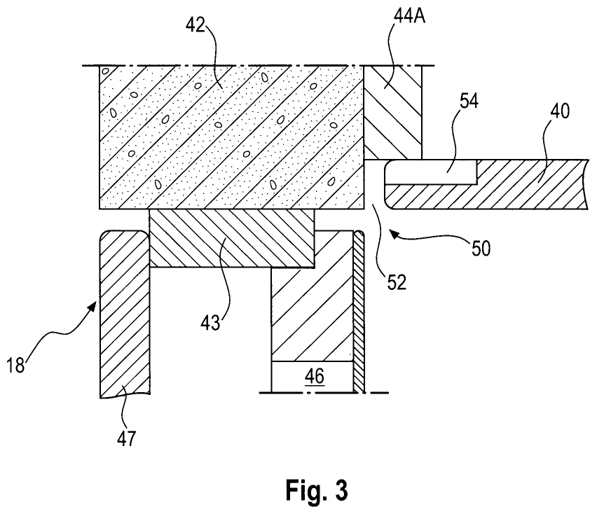

FIG. 3 is an enlarged sectional view of the view from FIG. 2

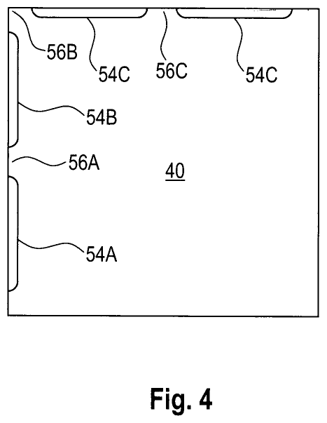

FIG. 4 is a view of a cladding panel for a heat chamber according to the invention

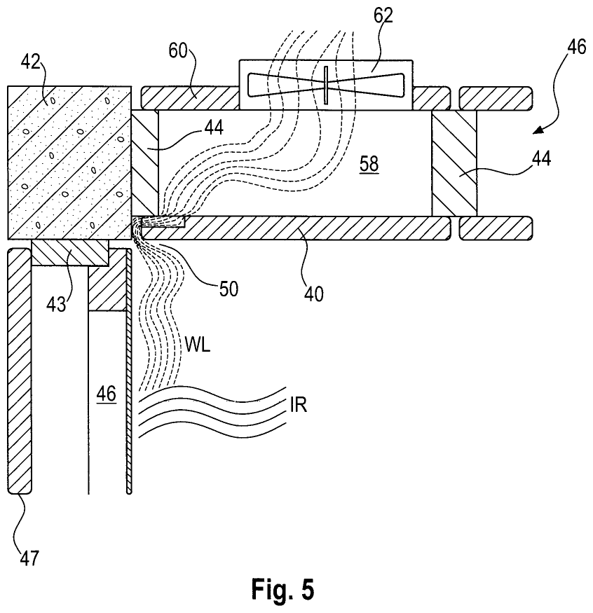

FIG. 5 shows an alternative embodiment of a heat chamber according to the invention in a sectional view

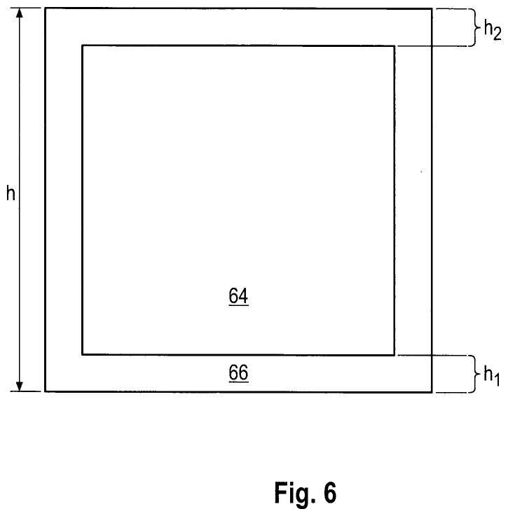

FIG. 6 shows a wall surface of a heat chamber in a schematic view

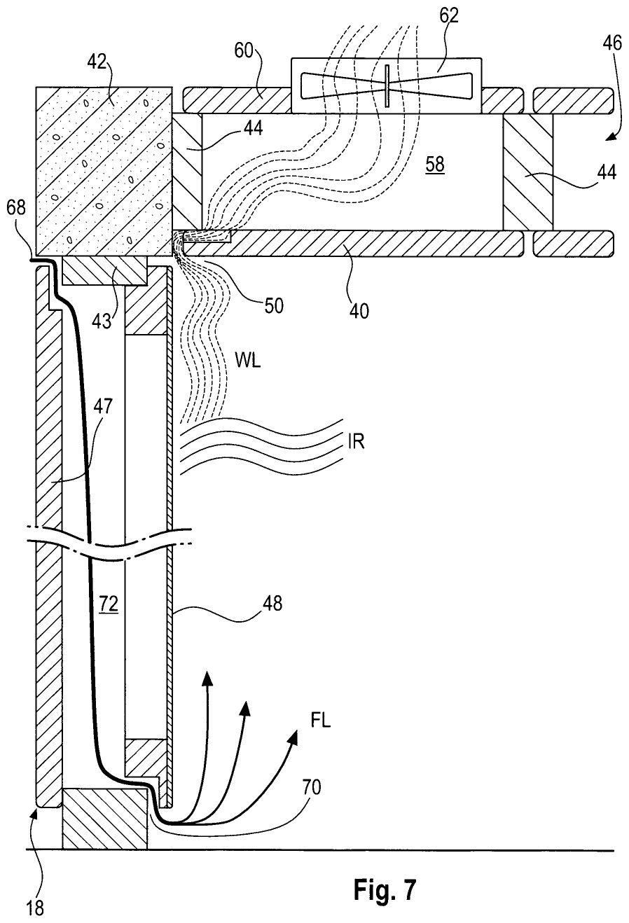

FIG. 7 shows a sectional view through a heat chamber according to the invention with fresh air supply

FIG. 1 presents the floor plan of a heat chamber in a slightly simplified schematic view. It is thus a depiction in a top view. A corresponding heat chamber may be configured according to the invention. The heat chamber is configured as training room 10 for physical training—this training may take place under the favorable influence of radiation. It comprises a front wall 12, in which a door 14 and an adjacent window element 16 are embedded. Front wall 12 connects to side wall 18, then to side wall 20, which forms the back wall, and then to side wall 22, which is opposite side wall 18. These side walls, together with the front wall, determine interior space 24 of training room 10.

A large-scale mirror 26 is provided on the end side of interior space 24 on side wall 20. An exercise bar 28 is provided on side wall 18. This type of exercise bar 28 allows for the support of the body due to a hand grip mounted at approximately belly height. It is quite possible that training cabin 10 is equipped with further and other exercise elements, for example, ceiling hooks may be provided, or also other training devices which are mounted on a wall or on a ceiling, or which are also free-standing in the space. A training bicycle might also be included.

A screen 30 is provided on side wall 22. Screen 30 may function for entertainment purposes and, for example, transmit television images. It may also provide information, in particular information regarding training progressions. This might include training instructions; however, it may also include measured values that relate to the training. At least the use duration of the heat chamber may be displayed there. As the present invention allows for the provision of large and flat wall panels, this information may also be projected quite well on them.

An interface panel 32 is located outside of the cabin in an area of front wall 12. Exterior settings may also be carried out on interface panel 32, for example, the temperature may be set. Furthermore, a user may log in there.

As depicted, the side walls are arranged parallel to supporting walls in the case of this heat cabin. Side wall 18 contacts supporting wall 34, side wall 20 contacts supporting wall 36, and side wall 22 contacts supporting wall 38. Such supporting walls may be provided specifically for the heat cabin. These supporting walls may also be the interior/exterior walls of an already existing space in which the heat cabin is integrated.

The heat cabin may be configured such that the side walls are self-supporting and the cabin does not require any additional supporting walls. The heat cabin may also be configured such that the supporting walls contribute to the mechanical stability of the cabin. The side walls may then function in particular for receiving heating elements. It is possible to provide heating elements and thereby also embed them flush into the walls, such that a substantial surface of the side walls is occupied. It is also possible to configure the side walls completely as heating elements.

FIG. 2 shows a heat chamber according to the invention in a sectional view. This is delimited on the left by side wall 18 and on the right by side wall 20. Ceiling 46 is substantially formed from cladding panels or ceiling panels 40A, 40B, and 40C. Ceiling 46 is held above the side walls by support beams 42. In addition, support battens 44 are provided. Individual panels 40 are held by this type of support battens 44. Infrared heating panels are provided flush to the wall, panel 48A in side wall 18 and panel 48B in side wall 20. These heating panels are held by support frame 43, among others.

Exhaust air openings are provided in the edge area of the ceiling, adjacent to support beams 42 and thus also to the side walls. Exhaust air opening 50A is depicted on the edge of ceiling panel 40A and exhaust air opening 50B is depicted on the edge of ceiling panel 40C.

The infrared heating panels radiate infrared waves (IR) into the cabin. Hot air (WL) is also thereby created. This hot air may rise from the area directly in front of the infrared radiant heaters to the ceiling. It is discharged through exhaust air openings 50.

FIG. 3 shows the situation already depicted in FIG. 2 in an enlarged sectional view.

Support batten 44A for the ceiling panels is mounted here on support beam 42. Furthermore, support frame 43 is mounted, which supports exterior wall panel 47 and heating panel 48.

Support batten 44A supports wall panel 40. Exhaust air opening 50 is provided at the edge of the ceiling adjacent to side wall 18. This consists of joint 52, which is formed between ceiling panel 40 and the adjacent wall and support construction, specifically between IR heating panel 48, support batten 43, and support beam 42. A recess 54 is formed in the ceiling panel in the area of joint 52. Air may flow out of the interior space of the heat chamber through joint 52 and through recess 54, so that joint 52 and recess 54 mutually form exhaust air opening 50. Recess 54 is covered from a view from below. This is aesthetically desirable, as the view of the support system, in this case specifically, for example, of support batten 44A, is thereby blocked. In addition, a curved air flow is thus achieved. It has been shown that this avoids drafts better, and also allows for a more efficient exhaust air guidance.

FIG. 4 shows ceiling panel 40 in a top view. Recesses are provided on two edges of the ceiling panel, recesses 54A, 54B, 54C, and 54D. Areas without recesses, thus contact surfaces 56, are provided in each case between the recesses. Contact surfaces 56A, 56B, and 56C allow for the easy mounting of the ceiling panel on a support system, for example, on support batten 44A.

FIG. 5 shows an alternative ceiling design according to the invention in a sectional view that substantially corresponds to the sectional view of FIG. 3. Ceiling 46 hereby comprises an interior and exterior ceiling. The interior ceiling is formed by ceiling panels 40 and the exterior ceiling is formed by exterior ceiling panels 60. The interior and exterior panels are held by support battens 44. Support battens 44 may be mounted in an appropriate way on the conventional support structure, for example, on support beams 42. Intermediate space 58 is formed between the interior ceiling and exterior ceiling, thus, for example, between interior ceiling panel 40 and exterior ceiling panel 60. Hot air (WL) may therefore flow from the cabin interior through exhaust air opening 50 into intermediate space 58. The hot air is sucked out of this intermediate space by fan 62, which is embedded in exterior ceiling panel 60.

FIG. 6 shows a view of a wall surface in a schematic view. The wall has a central surface 64 and an edge surface 66. The edge surface is a surrounding strip of constant width around the central surface. Thus, central surface 64 has substantially the same shape as the entire wall. In general, this is a rectangular shape. Depending on the width of the edge surface, central surface 64 may account for 60 to 99%, for example, also from 80 to 95% of the entire wall surface. The remaining wall surface is attributed to edge surface 66.

Depending on an embodiment, it is appropriate to select edge surface 66 as wider or narrower, so that the appropriate surface ratios mentioned above are achieved. The edge surfaces may thereby be configured to be structurally the same as the central surfaces, thus conceived of as surfaces, or structurally different from the central surfaces. In the context of the present invention, it has proven advantageous to provide all outlet openings in the area of the edge surface. This applies for wall surfaces and also analogously for ceiling surfaces.

It is likewise appropriate to provide fresh air openings, if needed, in the area of edge surfaces 66. It is particularly advantageous to provide fresh air openings in the lower wall area and the exhaust air openings in the upper wall area. If the wall has a total height of h, this lower wall area h1 may appropriately be between 1% and 20% or between 5% and 10% of the total height. Likewise, the upper area h2 may be between 1% and 20% and appropriately between 5% and 10%. It is particularly appropriate to provide fresh air openings in this lower wall area. It is likewise appropriate to provide exhaust air openings in the upper wall area. Expressed differently, the fresh air openings may be appropriately provided in the lower 10% of the wall height and the exhaust air openings may be appropriately provided in the upper 10% of the wall height.

FIG. 7 shows a heat chamber according to the invention with fresh air supply in a sectional view. The design of the heat chamber in relation to the exhaust air corresponds substantially to the embodiment shown in FIG. 5. In the depicted heat chamber, at least one fresh air supply is provided in side wall 18. This comprises a fresh air inlet 68 and a fresh air opening 70 in the lower area of the interior wall. Side wall 18 consists of an exterior wall panel 47 and an interior wall panel, which is formed by panel-shaped infrared radiator 48. Fresh air inlet 68 is provided in the upper area of exterior panel 47. An air space is provided between exterior panel 47 and interior panel 48 and functions as fresh air duct 72, through which the fresh air may thus be guided. The fresh air then exits below through fresh air opening 70. This is formed between panel 48 and the corresponding support beam. Fresh air opening 70 may be configured analogously to the exhaust air openings. A covered intake is thus also advantageous in the case of the fresh air opening. Furthermore, the fresh air opening may, for example, consist of a joint and a recess.

Fresh air opening 70 is located in the lower wall area. Fresh air FL entering the fresh air opening may thereby be guided past infrared radiator 48. It is heated thereby. A cold draft is thus avoided. In general, the heated air may be quickly guided to exhaust air openings 50 without a long convection path in the heat cabin. The draft-free use of the heat cabin is thus possible. The heating of the cabin may thus occur substantially without or with very minimal convection flows and heat is transmitted overwhelmingly through infrared radiation.

The exterior air, which is supplied through fresh air duct 72, may be significantly colder than the cabin air. Because fresh air duct 72 is guided past the back side of the heating elements, this leads to a first heating of the fresh air.

It is clear from the preceding description and figures, how a heat cabin may be produced overall, which may be heated efficiently and very pleasantly for a user, and which is able to be simultaneously cost efficient to produce and satisfies high aesthetic requirements.

### LIST OF REFERENCE NUMERALS

10 Heat cabin
12 Front wall
14 Door
16 Window element
18 Side wall
20 Side wall
22 Side wall
24 Interior space
26 Mirror
28 Exercise bar
30 Screen
32 Interface panel
34 Supporting interior/exterior wall
36 Supporting interior/exterior wall
38 Supporting interior/exterior wall
40 Panel (cladding panel)
42 Support beam
43 Support frame (Wall)
44 Support batten
46 Ceiling
47 Exterior wall panel
48 IR heating panel
50 Exhaust air opening
52 Joint
54 Recess (milled area)
56 Contact surface
58 Intermediate space
60 Exterior ceiling panel
62 Fan
64 Central surface
66 Edge surface
68 Fresh air inlet
70 Fresh air opening
72 Fresh air duct
IR Infrared radiation
WL Hot air
H Wall height
H1 Lower height area
H2 Upper height area
FL Fresh air

1. A heat cabin which is equipped with a heat supply and an exhaust air system, wherein the heat cabin comprises support beams and cladding panels and the cladding panels are aligned perpendicular to a wall or ceiling normal, and the exhaust air system comprises exhaust air openings in the cladding panels, whose shape is determined by the support beams and/or the cladding panels and which have no through passage parallel to the wall or ceiling normal.

2. The heat cabin according to claim 1, in which the heat supply is carried out be an infrared heater radiating into the cabin.

3. The heat cabin according to claim 1, in which at least one cladding panel comprises at least one longitudinal edge for contacting on a support beam, and the longitudinal edge intermittently has contact surfaces and openings, and the openings provide exhaust air openings.

4. The heat cabin according to claim 1, in which at least one cladding panel is manufactured from a composite material.

5. The heat cabin according to claim 1, in which the exhaust air openings are arranged on the ceiling.

6. The heat cabin according to claim 1, in which the exhaust air openings are arranged on the ceiling adjacent to the walls.

7. The heat cabin according to claim 1, in which a wall surface is equipped with an infrared heater, and at least one exhaust air opening is arranged in a cladding panel in the ceiling surface and above the infrared heater.

8. The heat cabin according to claim 1, which has an interior ceiling and an exterior ceiling.

9. The heat cabin according to claim 8, in which exhaust air openings are provided in the interior ceiling and exhaust air ducts are provided in the exterior ceiling.

10. The heat cabin according to claim 9, in which a negative pressure space is provided between the interior ceiling and the exterior ceiling.

11. The heat cabin according to claim 1, in which a fresh air supply is provided, which comprises fresh air openings in the cladding panels, whose shape is determined by the support beams and/or the cladding panels, and which have no through passage parallel to the wall or ceiling normal.

12. The heat cabin according to claim 11, in which heating elements are provided in the heat cabin, and the fresh air openings are arranged underneath the heating elements.

13. The heat cabin according to one of preceding claim 11, in which at least one wall surface has an interior wall and an exterior wall, and the fresh air openings are provided in the interior wall.

14. A method for heating a heat chamber in which at least one first infrared heating element is used, and a fresh air opening is arranged underneath the infrared heating element, and an exhaust air opening is arranged above the infrared heating element.

15. The method according to claim 14, in which wall and/or ceiling panels are used, and the exhaust air openings and/or the fresh air openings are covered by sections of the panels.
